(19) United States
(12) Patent Application Publication
(10) Pub. No.: US 2025/0361190 A1
(43) Pub. Date: Nov. 27, 2025

(54) ALUMINA-RICH ALUMINOSILICATE DIFFUSION BARRIERS FOR MULTILAYER ENVIRONMENTAL BARRIER COATINGS

(71) Applicant: OERLIKON METCO (US) INC., Westbury, NY (US)

(72) Inventor: Dianying CHEN, Westbury, NY (US)

(73) Assignee: OERLIKON METCO (US) INC., Westbury, NY (US)

(21) Appl. No.: 18/994,404

(22) PCT Filed: Aug. 30, 2023
(86) PCT No.: PCT/US2023/031501

§ 371 Date: Jan. 14, 2025

Related U.S. Application Data
(60) Provisional application No. 63/405,025, filed on Sep. 9, 2022.

(51) Int. Cl. C04B 41/52; C04B 35/80; C04B 41/50; C04B 41/87; C04B 41/89; C23C 4/02; C23C 4/10

(52) U.S. Cl. CPC C04B 41/52; C04B 35/80; C04B 41/5024; C04B 41/5032; C04B 41/5096; C04B 41/87; C04B 41/89; C23C 4/02; C23C 4/10; C04B 2235/3826; C04B 2235/5244

(57) ABSTRACT

A method for forming an environmental barrier coating (EBC) system on a surface of a ceramic matrix composite (CMC) to be protected and an EBC. The method includes applying an aluminosilicate composition over the surface of the CMC to be protected to form an aluminosilicate layer; and applying a rare-earth disilicate composition onto aluminosilicate layer.

### CROSS-REFERENCE TO RELATED APPLICATION

This International application claims the benefit/priority of U.S. Provisional Application No. 63/405,025 filed Sep. 9, 2022, the disclosure of which is expressly incorporated by reference herein in its entirety.

### BACKGROUND

### 1. Field of the Invention

Embodiments are directed to method of forming environmental barrier coatings (EBCs), which are needed to protect SiC based ceramic matrix composite (CMC) components from water vapor attack, and to the structure of such formed EBCs.

### 2. Discussion of Background Information

Environmental barrier coatings (EBCs) have been applied onto Si-based CMCs to protect these CMCs from oxidation and water vapor attack. Current EBC systems consist of a silicon bond coat layer applied to a SiC CMCs substrate surface to be protected followed by one or more rare-earth disilicate (e.g., Yb₂Si₂O₇) protective coating layers, as a top coat. It is known that, during the operational life of the CMCs components, oxidants, such as water vapor and oxygen, can diffuse through the EBC layers and oxidize the Si-based bond coat layer, which results in growth of a cristobalite SiO₂ thermally grown oxide (TGO) layer. This cristobalite SiO₂ TGO growth is a major contributor for failure of environmental barrier coatings (EBCs). Such EBCs will spall when the thermally grown oxides (TGO) reaches a threshold thickness. Therefore, it is important to slow down the TGO growth rate and improve the EBC coating durability.

### SUMMARY

Embodiments are directed to a method for forming an environmental barrier coating system (EBC) that includes applying a low oxidation diffusion barrier layer between a rare-earth disilicate layer and a Si-based bond coat to reduce undesired TGO growth rate. The low oxidation diffusion barrier layer specifically includes an Al₂O₃-rich aluminosilicate composition, which can be, e.g., 75-100% Al₂O₃ weight percent, and preferably 77%-87% Al₂O₃ with the balance of SiO₂. The reason to select Al₂O₃-rich aluminosilicate has two purposes:
1) Al₂O₃-rich aluminosilicate has a low oxidation diffusion coefficient, which can slow down oxidant diffusion; and
2) excess Al₂O₃, i.e., >75% Al₂O₃ in the Al₂O₃-rich aluminosilicate, can react with the cristobalite SiO₂ TGO to form two phases—Al₂O₃+mullite phase, which thus changes the TGO chemistries and avoids the cristobalite SiO₂ phase transformation during thermal cycling.

To reduce TGO growth rate in an EBC, a low oxidants/oxidation diffusion barrier layer is formed between a rare-earth disilicate layer and an Si-based bond coat layer on a substrate, preferably a surface of a CMC component. The oxidation diffusion barrier layer includes an Al₂O₃-rich aluminosilicate composition, which has a low oxidant/oxidation diffusion coefficient and can slow down oxidants' diffusion. Further, as excess Al₂O₃ may react with the cristobalite SiO₂ TGO to form mullite phase, the TGO chemistries can be changed so as to avoid a cristobalite SiO₂ phase transformation during thermal cycling.

Water vapor tests of the EBC according to embodiments, which were conducted at 1400° C. for 170 hours and 410 hours, have shown that the TGO growth in the multi-layer EBCs, i.e., EBCs with the Al₂O₃-rich aluminosilicate as intermediate layer, is ˜3 times slower than conventional EBCs, i.e., without an Al₂O₃-rich aluminosilicate intermediate layer.

The Al₂O₃-rich aluminosilicate coating can be deposited by: Air plasma spray; low pressure plasma spray; high-velocity oxy-fuel spray; suspension thermal spray; slurry coating process; chemical vapor deposition; or physical vapor deposition. Moreover, for a thermal spray, the Al₂O₃-rich aluminosilicate feedstock powder can be: fused/crushed; spray dry; agglomerated and sintered; or plasma densified. The particle size in the Al₂O₃-rich aluminosilicate feedstock powder can range from 11 μm to 105 μm, preferably between 11 μm and 62 μm.

The Al₂O₃-rich aluminosilicate coating layer formed in the multilayer EBC according to embodiments has a porosity ranging between >0% and 5% and a thickness ranging from 0.5 μm to 100 μm, preferably between 1-50 μm, more preferably between 5-20 μm.

Embodiments are directed to a method for forming an environmental barrier coating (EBC) system on a surface of a ceramic matrix composite (CMC) to be protected. The method includes applying an aluminosilicate composition over the surface of the CMC to be protected to form an aluminosilicate layer; and applying a rare-earth disilicate composition onto aluminosilicate layer.

In embodiments, the CMC can include a SiC/SiC CMC.

In accordance with other embodiments, the method may further include applying an Si-based bond coat layer directly onto the surface of the CMC to be protected. The aluminosilicate layer is applied directly onto the Si-based bond coat layer.

According to embodiments, the aluminosilicate composition may include an Al₂O₃-rich aluminosilicate composition comprising at least 75 wt % Al₂O₃, and the aluminosilicate layer includes an Al₂O₃-rich aluminosilicate layer. The Al₂O₃-rich aluminosilicate composition may include Al₂O₃ in excess of 75 wt %. Further, the Al₂O₃-rich aluminosilicate composition can include pure Al₂O₃. The Al₂O₃-rich aluminosilicate layer can be formed by one of: thermal spraying deposition, slurry coating processing, chemical vapor deposition or physical vapor deposition. Still further, when the Al₂O₃-rich aluminosilicate layer is formed by thermal spraying deposition, an Al₂O₃-rich aluminosilicate feedstock can include fused/crushed particles, spray dry particles, agglomerated and sintered particles or plasma densified particles. A particle size range of the Al₂O₃-rich aluminosilicate feedstock may be 11 μm-105 μm, and preferably 11 μm-62 μm. The Al₂O₃-rich aluminosilicate layer may have a porosity greater than 0% and less than 5% and a thickness ranging from 0.5 μm-100 μm, preferably between 1 μm-50 μm, more preferably 5 μm-20 μm.

In accordance with other embodiments, the rare-earth disilicate composition comprises Yb₂Si₂O₇, Er₂Si₂O₇, Lu₂Si₂O₇, or (YbYLuEr)₂Si₂O₇.

Embodiments are directed to an environmental barrier coating (EBC) system formed on a surface of a ceramic matrix composite (CMC) to be protected according to the above-described methods.

According to embodiments, the CMC may include a SiC/SiC CMC.

In accordance with other embodiments, the EBC can further include an Si-based bond coat layer directly on the surface of the CMC to be protected. The aluminosilicate layer may be directly on the Si-based bond coat layer.

In still other embodiments, the aluminosilicate layer may have an Al₂O₃-rich aluminosilicate composition comprising at least 75 wt % Al₂O₃, and the rare-earth disilicate layer may include a Yb₂Si₂O₇, Er₂Si₂O₇, Lu₂Si₂O₇, or (YbYLuEr)₂Si₂O₇ composition.

Embodiments are directed to an environmental barrier coating (EBC) system that includes an aluminosilicate layer; and a rare-earth disilicate layer formed on the aluminosilicate layer.

According to embodiments, the EBC can also include an Si-based bond coat layer, and the aluminosilicate layer can be applied directly onto the Si-based bond coat layer.

In other embodiments, the aluminosilicate layer can have an Al₂O₃-rich aluminosilicate composition comprising at least 75 wt % Al₂O₃. The Al₂O₃-rich aluminosilicate composition can include Al₂O₃ in excess of 75 wt %. Further, the Al₂O₃-rich aluminosilicate composition may include pure Al₂O₃. The Al₂O₃-rich aluminosilicate layer has a porosity greater than 0% and less than 5% and a thickness ranging from 0.5 μm-100 μm, preferably between 1 μm-50 μm, more preferably 5 μm-20 μm.

In accordance with still yet other embodiments, the rare-earth disilicate layer can include a Yb₂Si₂O₇, Er₂Si₂O₇, Lu₂Si₂O₇, or (YbYLuEr)₂Si₂O₇ composition.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIGS. 1A and 1B schematically illustrate multilayered EBCs according to embodiments;

FIG. 2 shows a phase diagram of Al₂O₃-SiO₂;

FIG. 3 shows diffusion coefficient of oxygen as a function of temperature;

FIG. 4A-4C show SEM images of microstructures of a known EBC (FIG. 4A) and EBCs according to embodiments (FIGS. 4B, 4C);

FIGS. 5A-5C show TGO growth behavior in a known EBC (FIG. 5A) and EBCs according to embodiments evaluated 1400° C. in 90 vol % H₂0-10 vol. % air for 170 hours (FIGS. 5B, 5C); and

FIGS. 6A-6C show TGO growth behavior in a known EBC (FIG. 6A) and EBCs according to embodiments evaluated 1400° C. in 90 vol % H₂0-10 vol. % air for 410 hours (FIGS. 6B, 6C).

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A coating system, in particular, an EBC coating system with Al₂O₃-rich aluminosilicate composition layer is deposited onto a surface of a SiC/SiC ceramic matrix composite (CMC) component or onto an Si-based bond coat layer in a multilayer EBC system. The Al₂O₃-rich aluminosilicate coating layer can slow down the oxidants diffusion and significantly reduce the TGO growth rate, while excess Al₂O₃ in the Al₂O₃-rich aluminosilicate coating layer can consume and react with the growing SiO₂ TGO, therefore changing the TGO growth behavior. The Al₂O₃ concentration in Al₂O₃-rich aluminosilicate composition is greater than, e.g., 75 weight percent with the balance of SiO₂.

TGO growth significantly depends on the coating materials' composition, microstructure and architectures. In order to reduce TGO growth rate, a low oxidants/oxidation diffusion barrier layer is applied between a rare-earth disilicate layer and a Si-based bond coat, which can slow down the oxidant diffusion. In embodiments, the oxidation diffusion barrier layer can include an Al₂O₃-rich aluminosilicate composition. The Al₂O₃-rich aluminosilicate layer of the oxidation diffusion barrier layer is advantageous because an Al₂O₃-rich aluminosilicate has a low oxidant diffusion coefficient that can slow down oxidants' diffusion. Moreover, excess Al₂O₃ in the Al₂O₃-rich aluminosilicate layer may react with the cristobalite SiO₂ TGO to form mullite phase, which can change the TGO chemistries and can avoid a cristobalite SiO₂ phase transformation during thermal cycling.

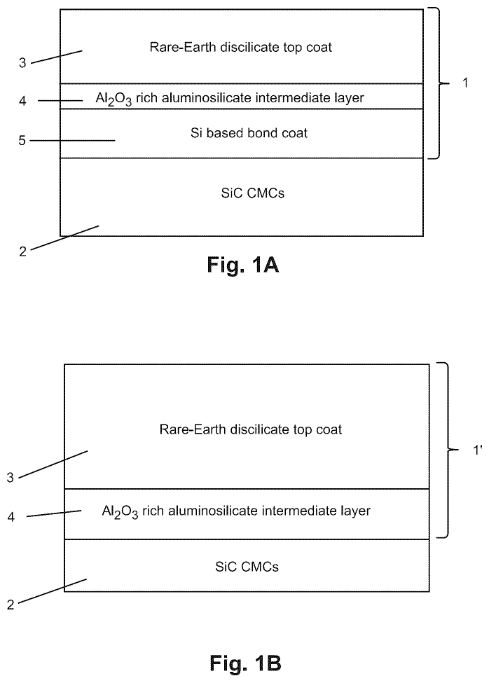

FIGS. 1A and 1B illustrate an exemplary embodiment of an EBC coating system 1, 1′ formed on SiC CMC components 2. FIG. 1A a tri-layer EBC coating system includes a rare-earth disilicate layer 3, e.g., Yb₂Si₂O₇, Er₂Si₂O₇, Lu₂Si₂O₇, (YbYLuEr)₂Si₂O₇, etc., formed on an Al₂O₃-rich aluminosilicate layer 4 and a Si-based bond coat 5, which is applied onto SiC CMC 2. In FIG. 1B, a two-layer EBC coating system 1′ includes a rare-earth disilicate layer 3, e.g., Yb₂Si₂O₇, Er₂Si₂O₇, Lu₂Si₂O₇, (YbYLuEr)₂Si₂O₇, etc., formed on an Al₂O₃-rich aluminosilicate layer 4, which is applied onto SiC CMC (or SiC/SiC CMC) 2 with an Si-based bond coating layer. In some applications, two-layer EBC coating system 1′ can be used without an Si-based bond coating layer so that the alumina rich aluminosilicate can be directly applied to SiC/SiC CMCs to protect CMCs. Moreover, as the SiC surface will be oxidized to form an SiO₂ TGO layer, the alumina rich aluminosilicate will slow down this TGO growth rate. Further, as the melting point of silicon is about 1414° C., two-layer EBC coating system 1′ can be advantageous in high temperature environments greater than 1400° C.

The Al₂O₃-rich aluminosilicate coating layer of EBC coating systems 1, 1′ can be formed via thermal spraying deposition, including air plasma spraying deposition, low pressure plasma spraying deposition, high-velocity oxy-fuel spraying deposition, and suspension thermal spraying deposition, slurry coating processing, chemical vapor deposition or physical vapor deposition. Moreover, when the intermediate coating is applied by one of the thermal spraying deposition processes, the Al₂O₃-rich aluminosilicate feedstock powder can be made via fused/crushed particles, spray dry particles, agglomerated and sintered particles or plasma densified particles. The particle size in the Al₂O₃-rich aluminosilicate feedstock ranges from 11 μm to 105 μm, and preferably between 11 μm and 62 μm.

The Al₂O₃-rich aluminosilicate intermediate coating in EBC systems 1, 1′ can have a porosity that is greater than 0% and less than 5% and a thickness ranging from 0.5 μm to 100 μm, preferably between 1 μm-50 μm, and more preferably between 5 μm-20 μm.

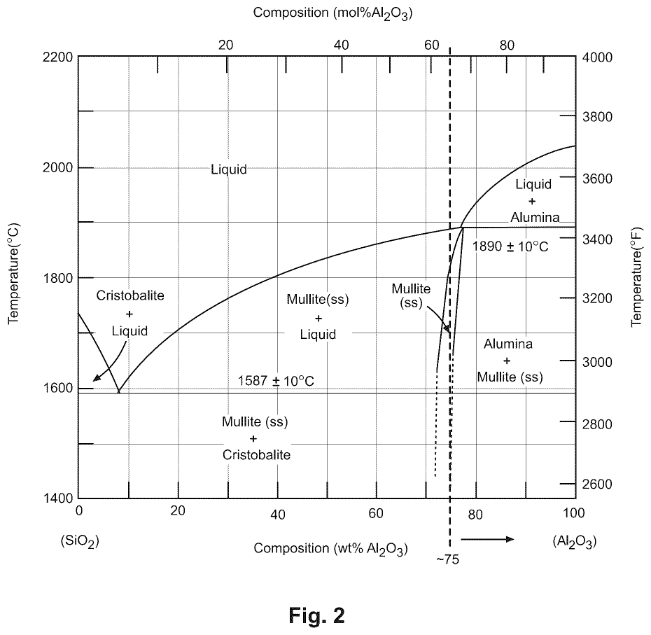

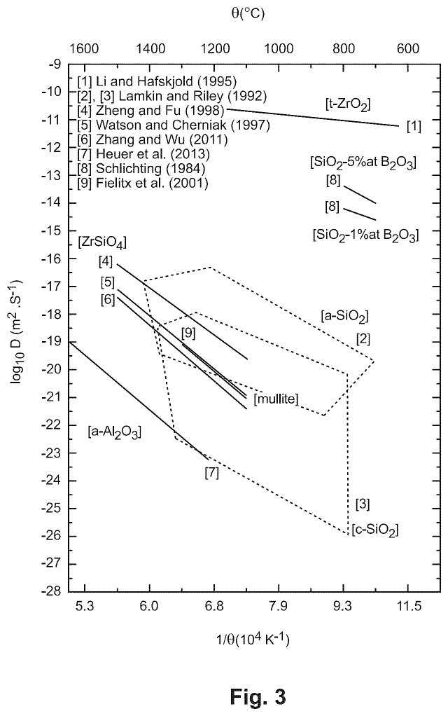

FIG. 2 shows a phase diagram of the Al₂O₃-SiO₂ from Frederic J. Klug et al., “Alumina-Silica Phase Diagram in the Mullite Region,” J. Am. Ceram. Soc., Vol. 70, No. 10, pp. 750-59 (1987). In FIG. 2, it can be seen that an Al₂O₃-rich aluminosilicate material, from which the Al₂O₃-rich aluminosilicate layer 3 in FIGS. 1A and 1B is formed, at, e.g., greater than 75 wt % Al₂O₃, includes excess alumina, as compared to a stoichiometric mullite. This excess Al₂O₃ has been found to react with and consume the SiO₂ TGO, therefore modifying TGO growth behavior. Moreover, FIG. 3, which is from Franck Nozahic et al., “Self-healing thermal barrier coating systems fabricated by spark plasma sintering,” Materials & Design, 2018, No. 143. pp. 204-213 (2018), shows the diffusion coefficient of oxygen as a function of temperature for various compositions, including alumina and mullite. As shown in FIG. 3, Al₂O₃ and mullite have a low diffusion coefficient of oxygen, as compared to other compositions.

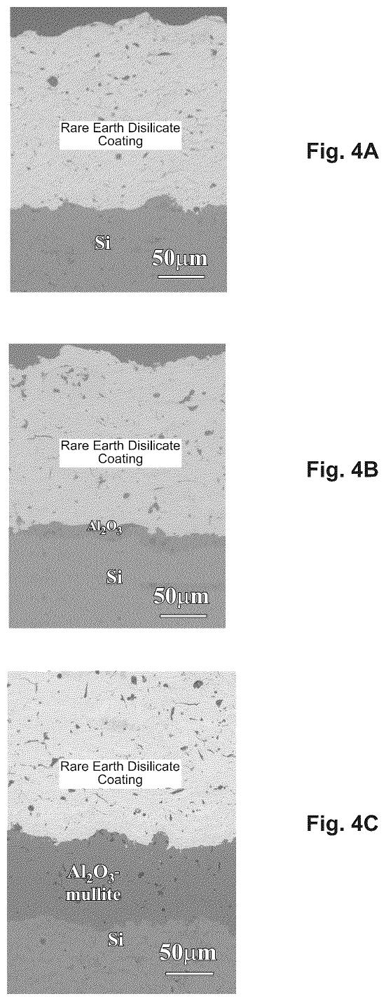

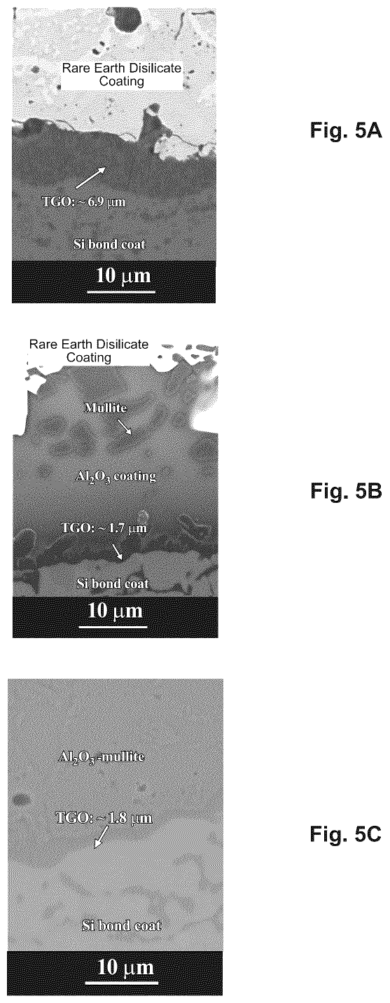

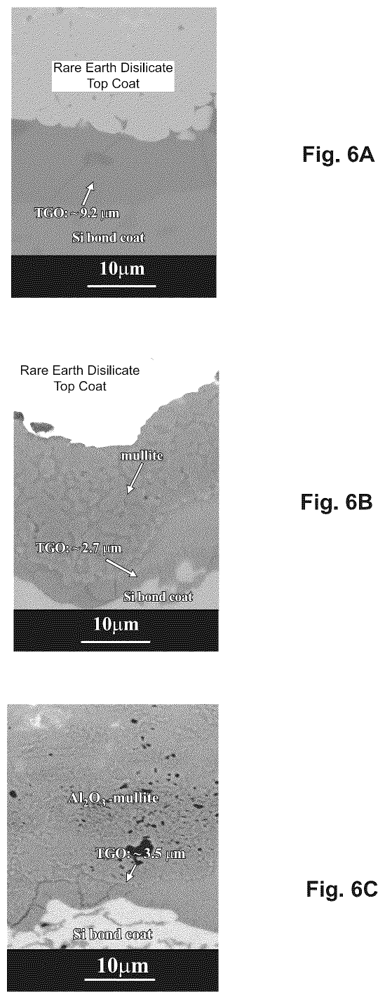

FIG. 4A shows an SEM image of a microstructure of a known bi-layer EBC system consisting of a rare-earth disilicate layer, such as Yb₂Si₂O₇, Er₂Si₂O₇, Lu₂Si₂O₇, (YbYLuEr)₂Si₂O₇, etc., and a Si-based bond coat layer. FIG. 5A shows growth behavior of TGO (˜6.9 μm) on the Si bond coating layer when the known bi-layer EBC system of FIG. 4A is evaluated in a 90% H₂0-10% air environment at 1400° C. for 170 hours. FIG. 6A shows the continued growth behavior of TGO (˜9.2 μm) on the Si bond coating layer when the known bi-layer EBC system of FIG. 4A is evaluated in a 90% H₂0-10% air environment at 1400° C. for 410 hours.

In an exemplary embodiment, albeit an extreme example, FIG. 4B shows an SEM image of a microstructure of a tri-layer EBC system that includes a rare-earth disilicate layer, such as Yb₂Si₂O₇, Er₂Si₂O₇, Lu₂Si₂O₇, (YbYLuEr)₂Si₂O₇, etc., an Al₂O₃-rich aluminosilicate composition layer, i.e., a pure Al₂O₃ intermediate layer (without SiO₂)) and a Si-based bond coat layer. FIG. 5B shows growth behavior of TGO (˜1.7 μm) on the Si bond coating layer when the EBC system of FIG. 4B is evaluated in a 90% H₂0-10% air environment at 1400° C. for 170 hours. Moreover, as this pure Al₂O₃ composition has an Al₂O₃ concentration in Al₂O₃-rich aluminosilicate composition that is in excess of 75 weight percent (with the balance of SiO₂), this excess Al₂O₃ can consume and react with the grown SiO₂ TGO and therefore, change the TGO growth behavior. As shown in FIG. 5B, it can be seen that excess Al₂O₃ in the intermediate layer, i.e., Al₂O₃ in excess of 75 wt %, is converted to the mullite phase due to this reaction between Al₂O₃ and SiO₂. FIG. 6B shows the continued growth behavior of TGO (˜2.7 μm) on the Si bond coating layer when the EBC system of FIG. 4B is evaluated in a 90% H₂0-10% air environment at 1400° C. for 410 hours, as well as additional mullite phases can be observed in the Al₂O₃ intermediate layer in FIG. 6B, resulting from a continuing reaction between Al₂O₃ and SiO₂, where the SiO₂ TGO will diffuse up to the Al₂O₃ intermediate layer to react with Al₂O₃.

In another exemplary embodiment, FIG. 4C shows an SEM image of a microstructure of a tri-layer EBC system that includes a rare-earth disilicate layer, such as Yb₂Si₂O₇, Er₂Si₂O₇, Lu₂Si₂O₇, (YbYLuEr)₂Si₂O₇, etc., an Al₂O₃-rich aluminosilicate composition layer, i.e., alumina-mullite comprised of 77 wt % Al₂O₃—23 wt % SiO₂, and a Si-based bond coat layer. FIG. 5C shows growth behavior of TGO (˜1.8 μm) on the Si bond coating layer when the EBC system of FIG. 4C is evaluated in a 90% H₂0-10% air environment at 1400° C. for 170 hours. FIG. 6C shows the continued growth behavior of TGO (˜3.5 μm) on the Si bond coating layer when the EBC system of FIG. 4C is evaluated in a 90% H₂0-10% air environment at 1400° C. for 410 hours.

Thus, it is apparent that the exemplary embodiments discussed above in FIGS. 4B (and FIGS. 5B and 6B) and 4C (and FIGS. 5C and 6C) having an Al₂O₃-rich aluminosilicate intermediate layer is very effective to slow down the TGO growth rate in the EBCs as compared with the EBCs without the Al₂O₃-rich aluminosilicate layer, as in FIGS. 4A (and 5A and 6A).

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A method for forming an environmental barrier coating (EBC) system on a surface of a ceramic matrix composite (CMC) to be protected, comprising:
applying an aluminosilicate composition over the surface of the CMC to be protected to form an aluminosilicate layer; and
applying a rare-earth disilicate composition onto aluminosilicate layer,
wherein the aluminosilicate composition comprises an Al₂O₃-rich aluminosilicate composition comprising between 75 wt % and 100 wt %, and
the aluminosilicate layer comprises an Al₂O₃-rich aluminosilicate layer.

2. The method according to claim 1, wherein the CMC comprises a SiC/SiC CMC.

3. The method according to claim 1, further comprising applying an Si-based bond coat layer directly onto the surface of the CMC to be protected,
wherein the aluminosilicate layer is applied directly onto the Si-based bond coat layer.

4. (canceled)

5. The method according to claim 1, wherein the Al₂O₃-rich aluminosilicate composition is between 77 wt % and 87 wt %.

6. (canceled)

7. The method according to claim 1, wherein the Al₂O₃-rich aluminosilicate layer is formed by one of: thermal spraying deposition, slurry coating processing, chemical vapor deposition or physical vapor deposition

8. The method according to claim 7, wherein, when the Al₂O₃-rich aluminosilicate layer is formed by thermal spraying deposition, an Al₂O₃-rich aluminosilicate feedstock comprises fused/crushed particles, spray dry particles, agglomerated and sintered particles or plasma densified particles.

9. The method according to claim 8, wherein a particle size range of the Al₂O₃-rich aluminosilicate feedstock is 11 μm-105 μm, and preferably 11 μm-62 μm.

10. The method according to claim 1, wherein the Al₂O₃-rich aluminosilicate layer has a porosity greater than 0% and less than 5% and a thickness ranging from 0.5 μm-100 μm, preferably between 1 μm-50 μm, more preferably 5 μm-20 μm.

11. The method according to claim 1, wherein the rare-earth disilicate composition comprises one of Yb₂Si₂O₇, Er₂Si₂O₇, Lu₂Si₂O₇, or (YbYLuEr)₂Si₂O₇.

12. An environmental barrier coating (EBC) system formed on a surface of a ceramic matrix composite (CMC) to be protected according to the method of claim 1.

13. The EBC according to claim 12, wherein the CMC comprises SiC/SiC CMC.

14. The EBC according to claim 12, further comprises an Si-based bond coat layer directly on the surface of the CMC to be protected,
wherein the aluminosilicate layer is directly on the Si-based bond coat layer.

15. The EBC according to claim 12, wherein the rare-earth disilicate layer comprises at least one of a Yb₂Si₂O₇, Er₂Si₂O₇, Lu₂Si₂O₇, or (YbYLuEr)₂Si₂O₇ composition.

16. An environmental barrier coating (EBC) system comprising:
an aluminosilicate layer; and
a rare-earth disilicate layer formed on the aluminosilicate layer,
wherein the aluminosilicate layer has an Al₂O₃-rich aluminosilicate composition comprising between 75 wt % and 100 wt %.

17. The EBC according to claim 16, further comprising an Si-based bond coat layer, wherein the aluminosilicate layer is applied directly onto the Si-based bond coat layer.

18. (canceled)

19. The EBC according to claim 16, wherein the Al₂O₃-rich aluminosilicate composition is between 77 wt % and 87 wt %.

20. (canceled)

21. The EBC according to claim 16, wherein the Al₂O₃-rich aluminosilicate layer has a porosity greater than 0% and less than 5% and a thickness ranging from 0.5 μm-100 μm, preferably between 1 μm-50 μm, more preferably 5 μm-20 μm.

22. The EBC according to claim 16, wherein the rare-earth disilicate layer comprises at least one of a Yb₂Si₂O₇, Er₂Si₂O₇, Lu₂Si₂O₇, or (YbYLuEr)₂Si₂O₇ composition.
